(19) United States
(12) Patent Application Publication
(10) Pub. No.: US 2023/0018865 A1
(43) Pub. Date: Jan. 19, 2023

(54) LIQUID HAND DISHWASHING CLEANING COMPOSITION

(71) Applicant: The Procter & Gamble Company, Cincinnati, OH (US)

(72) Inventors: Karl Ghislain BRAECKMAN, Gerpinnes (BE); Emmanuel Marie Francois Rene DE REYDET DE VULPILLIERES, Lincent (BE); Rocco TARCHINI, Brussels (BE); Alexandra SOLLIER, Vilvoorde (BE); Iliana Del Carmen ROJAS NAVA, Heist Op Den Berg (BE)

(21) Appl. No.: 17/861,286

(22) Filed: Jul. 11, 2022

(30) Foreign Application Priority Data
Jul. 16, 2021 (JP) 2021-117530
Jun. 30, 2022 (JP) 2022-105824

(51) Int. Cl. C11D 1/94; C11D 11/00

(52) U.S. Cl. CPC C11D 1/94; C11D 11/0023; C11D 1/662

(57) ABSTRACT

A liquid hand dishwashing cleaning composition having from 15% to 40% by weight of the composition of a surfactant system. The surfactant system has an anionic surfactant and from 5% to 18.4% of a nonionic surfactant package by weight of the composition. The weight ratio of the nonionic surfactant package to the anionic surfactant ranges from 1:1 to 3:1. The nonionic surfactant has a mixture of a first nonionic surfactant and a second nonionic surfactant. The first nonionic surfactant includes an alkyl polyglucoside surfactant. The surfactant system further includes a co-surfactant. The weight ratio of the anionic surfactant to the co-surfactant ranges from 1:1 to 8:1. The composition is free of fatty acid or salts thereof.

### TECHNICAL FIELD

The present disclosure relates to a liquid hand dishwashing cleaning composition. In particular, it relates to a liquid hand dishwashing cleaning composition comprising a surfactant system including an anionic surfactant, a co-surfactant and a mixture of first and second nonionic surfactants for delivering a good sudsing and grease cleaning profile under different consumer washing habits while exhibiting a good physical stability profile across ageing conditions.

### BACKGROUND

Hand-dishwashing cleaning compositions are formulated to be highly effective at removing grease from soiled dishes, while sustaining a rich foaming profile during the washing process. In particular, to improve detergency against grease, hand-dishwashing cleaning compositions have conventionally been blended with components exhibiting a cleaning effect such as for example, with an anionic surfactant, a nonionic surfactant, and an amphoteric surfactant. Moreover, flash suds, attributable to a visual signal of detergency performance, is important to many consumers.

### SUMMARY

To provide these benefits, liquid hand dish detergent compositions often contain anionic surfactants having a relatively high degree of alkoxylation, especially ethoxylation, making them more water soluble. However, a drawback to these highly alkoxylated anionic surfactants is sacrificing efficient grease or oil removal. Further, relatively high levels of surfactants, although help to provide grease cleaning benefits, may pose at least one of several challenges.

For example, alkyl sulfate anionic surfactants are used, but the levels are to be minimized otherwise the anionic surfactants may cause storage stability issues. Additionally, anionic surfactant selection and levels are to be considered as they may negatively impact foamability and/or suds mileage in the presence of greasy soils. Additionally, use of nonionic surfactants in high levels pose challenges for negatively impacting suds mileage as well as grease cleaning. Given these challenges, formulators typically have surfactant limitations, which in turn minimizes the ability to formulate a composition with all of the benefits of storage stability, grease cleaning, and foamability, e.g. suds mileage and flash suds. This reduces the breadth of available benefits and thus the hand-dishwashing and cleaning experience to users. However, there remains a need for improved liquid hand-dishwashing compositions that provide all of the benefits of storage stability, grease cleaning and foamability, e.g. suds mileage and flash suds.

The present disclosure relates to a liquid hand dishwashing cleaning composition comprising: from 15% to 40% of a surfactant system by weight of the liquid hand dishwashing cleaning composition, wherein: the surfactant system comprises: an anionic surfactant, from 5% to 18.4% of a nonionic surfactant package by weight of the liquid hand dishwashing cleaning composition, and a co-surfactant; a weight ratio of the nonionic surfactant package to the anionic surfactant is from 1:1 to 3:1; the nonionic surfactant package comprises a mixture of a first nonionic surfactant and a second nonionic surfactant; the first nonionic surfactant is an alkyl polyglucoside surfactant; a weight ratio of the anionic surfactant to the co-surfactant is from 1:1 to 8:1; and the liquid hand dishwashing cleaning composition is free of fatty acid or salts thereof.

### DETAILED DESCRIPTION

The present disclosure relates to a liquid hand dishwashing cleaning composition (hereinafter “liquid cleaning composition”) that provides storage stability, flash suds, suds mileage and grease cleaning benefits, thereby providing users with a well-rounded option for cleaning dishes. Specifically, the liquid cleaning composition comprises from 15% to 40% by weight of the composition of a surfactant system. The surfactant system comprises an anionic surfactant and a nonionic surfactant, wherein a weight ratio of the nonionic surfactant to the anionic surfactant is of from 1:1 to 3:1. The nonionic surfactant is in an amount of from 5% to 18.4% by weight of the composition. The nonionic surfactant comprises a first nonionic surfactant and a second nonionic surfactant. The first nonionic surfactant is an alkyl polyglucoside surfactant. The second nonionic surfactant is a different nonionic surfactant from the alkyl polyglucoside surfactant. The surfactant system further comprises a co-surfactant, wherein the weight ratio of the anionic surfactant to the co-surfactant is from 1:1 to 8:1. The composition is free of fatty acid or salts thereof.

A technical effect of a liquid cleaning composition free of fatty acid or salts thereof and having the weight ratio of the nonionic surfactant to the anionic surfactant of from 1:1 to 3:1, the nonionic surfactant in a level of from 5% to 18.4% by weight of the composition, and the weight ratio of the anionic surfactant to the co-surfactant of from 1:1 to 8:1, can measurably improve flash suds, suds mileage, grease cleaning and exhibits stability in low temperature and no phase split at room temperature. The composition according to the disclosure has also been found to deliver good product dissolution as well as good rinse feel properties, e.g. non-greasy feel of the rinse solution as well as non-slippery feel of dishware.

Prior to describing the present composition in detail, the following terms are defined for clarity. Terms not defined should be given their ordinary meaning as understood by a skilled person in the relevant art.

As used herein, articles such as “a” and “an” when used in a claim, are understood to mean one or more of what is claimed or described.

The term “comprising” as used herein means that steps and ingredients other than those specifically mentioned can be added. This term encompasses the terms "consisting of'' and "consisting essentially of." The compositions of the present disclosure can comprise, consist of, and consist essentially of the essential elements and limitations of the composition described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt% by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes initial suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high initial suds volume and/or sustained suds volume, particularly during a substantial portion of or for the entire manual dishwashing process. This is important as the consumer uses high suds as an indicator that enough cleaning composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

“Flash suds” as used herein refers to a total volume of foam generated according to the Test Method for Evaluating Flash Suds Performance described hereinafter under Test Methods Section of the present application. Flash suds also known as initial suds that is generated upon initial use with a sponge for hand dishwashing and signals speed of product effectiveness to the consumer.

It is understood that the test methods that are disclosed in the Test Methods Section of the present application must be used to determine the respective values of the parameters of Applicants’ compositions as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Cleaning Composition

The cleaning composition is a liquid cleaning composition, preferably a liquid hand dishwashing cleaning composition, and hence is in liquid form. The liquid cleaning composition is preferably an aqueous cleaning composition. As such, the composition can comprise from 50% to 85%, preferably from 50% to 75%, by weight of the total composition of water.

The liquid cleaning composition has a pH greater than or equal to 6.0, or a pH of from 6.0 to 12.0, from 6.5 to 11.0, from 7.0 to 10.0, or different combinations of the upper and lower values described above or combinations of any value in the ranges listed above, measured as a 10% aqueous solution in demineralized water at 20° C.

The liquid cleaning compositions of the present disclosure can be Newtonian or non-Newtonian, preferably Newtonian. The liquid cleaning composition preferably comprises a viscosity of less than or equal to 500 cps, less than or equal to 300 cps, from 50 to 300 cps, or different combinations of the upper and lower values described above or combinations of any value in the ranges listed above, measured at 20° C. with a Brookfield RT Viscometer using spindle 18 with the RPM of the viscometer adjusted to achieve a torque of between 40% and 60%.

### Surfactant System

The liquid cleaning compositions of the present disclosure may comprise from 5% to 50% from 8% to 45%, from 15% to 40% or different combinations of the upper and lower percentages described above or combinations of any value in the ranges listed above, by weight of the composition of a surfactant system. The surfactant system comprises an anionic surfactant, and a nonionic surfactant in a level of from 5% to 18.4% by weight of the composition, wherein a weight ratio of the nonionic surfactant to the anionic surfactant is from 1:1 to 3:1. The surfactant system further comprises a co-surfactant, wherein a weight ratio of the anionic surfactant to the co-surfactant is from 1:1 to 8:1.

Effective cleaning and stability benefits of providing a liquid cleaning composition free of fatty acid and salts thereof, and comprising a surfactant system having the nonionic surfactant and the anionic surfactant in a weight ratio of from 1:1 to 3:1 and including an alkyl polyglucoside surfactant is demonstrated in Example 1. Specifically, data in Example 1 shows that an Inventive Composition 1 having a nonionic surfactant in a level of 14.2% by weight of the composition, and a weight ratio of a nonionic surfactant (alkyl polyglucoside nonionic surfactant and a different nonionic surfactant from the alkyl polyglucoside nonionic surfactant) to an anionic surfactant (alkyl ethoxy sulfate anionic surfactant) of 1.5:1 within the weight ratio of from 1:1 to 3:1 demonstrates the best performance results for all the assessed benefits, i.e. overall flash suds superiority (154 mL of foam generated), exhibiting stability in low temperature, no phase split at room temperature, and achieving excellent suds mileage (score of 121) and grease cleaning results (score of 98). This is an improvement on all the benefits relative to a Comparative Composition A which does not have the nonionic surfactant in a level less than or equal to 18.4% by weight of the composition (19% by weight of the composition) and a Comparative Composition B which does not have a weight ratio of the nonionic surfactant to the anionic surfactant of greater than 1:1 (1:1.3).

In an exemplary example, the present disclosure also relates to a liquid hand dishwashing cleaning composition comprising:

(a) from 15% to 40% of a surfactant system by weight of the composition, wherein the surfactant system comprises:
(i) an anionic surfactant selected from the group consisting of: alkyl sulphate anionic surfactant, alkyl sulphonate anionic surfactant, alkyl sulphosuccinate and dialkyl sulphosuccinate ester surfactants and mixtures thereof
(ii) from 5% to 18.4% of a nonionic surfactant by weight of the composition, wherein the nonionic surfactant comprises a first nonionic surfactant and a second nonionic surfactant, wherein the first nonionic surfactant is an alkyl polyglucoside nonionic surfactant: and (iii) a co-surfactant
wherein the weight ratio of the nonionic surfactant to the anionic surfactant is from 1:1 to 3:1; wherein the nonionic surfactant comprises a mixture of a first nonionic surfactant and a second nonionic surfactant, wherein the first nonionic surfactant is an alkyl polyglucoside surfactant; wherein the weight ratio of the anionic surfactant to the co-surfactant is from 1:1 to 8:1; and wherein the composition is free of fatty acid or salts thereof.

### Nonionic Surfactant

The surfactant system comprises at least 40%, from 40% to 65.9%, from 40% to 65%, or different combinations of the upper and lower values described above or combinations of any value in the ranges listed above, by weight of the composition of a nonionic surfactant.

The nonionic surfactant may be in an amount of from 5.0% to 18.4%, from 10.0% to 17.0%, from 12.0% to 16.0% or different combinations of the upper and lower percentages described above or combinations of any value in the ranges listed above, by weight of the composition.

The weight ratio of the nonionic surfactant to the anionic surfactant may be from 1:1 to 3:1, 1:1, from 1.1:1 to 3:1, from 1.3:1 to 2:1, or different combinations of the upper and lower ratios described above or combinations of any ratio in the ranges listed above.

The nonionic surfactant comprises a first nonionic surfactant and a second nonionic surfactant wherein the first nonionic surfactant is an alkyl polyglucoside nonionic surfactant.

Providing a mixture of first and second nonionic surfactants in a liquid cleaning composition according to the present disclosure and the effective cleaning and stability benefits are demonstrated in Example 2. Specifically, data in Example 2 shows that an Inventive Composition 1 having a C10 to C16 alkyl polyglucoside nonionic surfactant (as a non-limiting example of an alkyl polyglucoside nonionic surfactant) and a C9 to C11 alkyl ethoxylated alcohol nonionic surfactant (as a non-limiting example of a second nonionic surfactant) demonstrates the best performance results for all the assessed benefits, i.e. overall flash suds superiority (154 mL of foam generated), exhibiting stability in low temperature, no phase split at room temperature, and achieving excellent suds mileage (score of 121) and grease cleaning results (score of 98). This is an improvement on all the benefits relative to a Comparative Composition C without a mixture of two different nonionic surfactants and only a single alkyl polyglucoside nonionic surfactant (a C10 to C16 alkyl polyglucoside nonionic surfactant) which exhibits overall poorer suds mileage, and poor grease cleaning results relative to Inventive Composition 1 based on the lower scores described in Example 2. A Comparative Composition D having a single nonionic surfactant different from the alkyl polyglucoside nonionic surfactant, i.e. having an alkyl ethoxylated alcohol nonionic surfactant, also exhibits poorer flash suds results relative to the Inventive Composition 1.

The weight ratio of the first nonionic surfactant to the second nonionic surfactant may be from 3:1 to 1:3, from 2:1 to 1:2, from 1.5:1 to 1:1.5 or different combinations of the upper and lower ratios described above or combinations of any ratio in the ranges listed above. The nonionic surfactant may consist of the first nonionic surfactant and the second nonionic surfactant.

### First Nonionic Surfactant- Alkyl Polyglucoside Nonionic Surfactant

The surfactant system of the composition of the present disclosure may comprise from 10% to 50%, preferably from 15% to 40%, more preferably from 20% to 30%, by weight of the surfactant system, of a first nonionic surfactant. The first nonionic surfactant is an alkyl polyglucoside nonionic surfactant.

The alkyl polyglucoside nonionic surfactant can be present in the liquid cleaning composition at a level of from 0.5% to 20%, from 0.75% to 15%, from 1% to 12%, from 2% to 10% or different combinations of the upper and lower percentages described above or combinations of any value in the ranges listed above by weight of the composition.

Alkyl polyglucoside nonionic surfactants are typically more sudsing than other nonionic surfactants such as alkyl ethoxlated alcohols.

The alkyl polyglucoside surfactant may be selected from C8-C18 alkyl polyglucosides, preferably wherein the alkyl polyglucoside surfactant is a C8-C14 alkyl polyglucoside, more preferably a C12-C14 alkyl polyglucoside and wherein the alkyl polyglucoside surfactant has a number average degree of polymerization of from 0.1 to 3.0, preferably from 1.0 to 2.0, more preferably from 1.2 to 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, Glucopon® 650 EC/MB from BASF Corporation). Glucopon® 600CSUP is a preferred mid to long chain APG surfactant.

C8-C18 alkyl polyglucosides may comprise unfractionated fraction nonionic surfactants, while C8-C14 alkyl polyglucosides may comprise fractionated fraction nonionic surfactants within C8-C18 alkyl polyglucosides and C12-C14 alkyl polyglucosides may comprise further fractionated fraction nonionic surfactants. For example, a C12-C14 alkyl polyglucoside nonionic surfactant may comprise left over chains present of other alkyl chain length. It will be appreciated by a person skilled in the art that this is common in surfactant manufacturing processes, and that the presence of such left over chains do not materially impact or cause a difference in the characteristics of the C12-C14 alkyl polyglucosides.

The C12-C14 alkyl polyglucoside may also be a blend of short chain alkyl polyglucoside surfactant having an alkyl chain comprising 10 carbon atoms or less, and long chain alkyl polyglucoside surfactant having an alkyl chain comprising greater than 10 carbon atoms (Bimodal distribution), however a monomodal distribution around C12-C14 alkyl polyglucoside is preferred.

In an exemplary example, the present disclosure is directed to the use of a nonionic surfactant comprising an alkyl polyglucoside nonionic surfactant in a phase-stable liquid hand dishwashing cleaning composition for providing a plurality of benefits for cleaning a target surface, preferably wherein the target surface is a dish, wherein the composition comprises a surfactant system comprising the nonionic surfactant and an anionic surfactant, wherein the weight ratio of the nonionic surfactant to the anionic surfactant is greater than 1:1 and the alkyl polyglucoside nonionic surfactant is in an amount of 10% to 50%, preferably 15% to 40%, more preferably 20% to 30% by weight of the surfactant system, wherein the plurality of benefits comprises grease cleaning, suds mileage, and flash suds.

### Second Nonionic Surfactant

The surfactant system of the composition of the present disclosure may further comprise from 10% to 50%, preferably from 15% to 40%, more preferably from 20% to 30%, by weight of the surfactant system, of a second nonionic surfactant. The second nonionic surfactant can be present in the liquid cleaning composition at a level of from 0.5% to 20%, from 0.75% to 15%, from 1% to 12%, from 2% to 10% or different combinations of the upper and lower percentages described above or combinations of any value in the ranges listed above by weight of the composition.

The second nonionic surfactant may be an alkoxylated alcohol nonionic surfactant, alkoxylated alkyl phenol nonionic surfactant, alkoxylated fatty acids, alkoxylated fatty esters or oils, alkoxylated amines or fatty acid amides, fatty acid esters of polyhydroxy compounds including glycerol/sorbitol/sucrose, or mixtures thereof, preferably an alkoxylated alcohol nonionic surfactant, most preferably an ethoxylated alcohol nonionic surfactant.

### Alkoxylated Alcohol Nonionic Surfactant

Preferably, the alkoxylated alcohol nonionic surfactant is a linear or branched, primary or secondary alkyl alkoxylated nonionic surfactant, preferably an alkyl ethoxylated nonionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Anionic Surfactant

The surfactant system comprises an anionic surfactant. The surfactant system can comprise less than 50%, preferably from 10% to 45%, more preferably from 20% to 45% or different combinations of the upper and lower percentages described above or combinations of any value in the ranges listed above by weight of the surfactant system of the anionic surfactant. The surfactant system is free of fatty acid or salt thereof, since such fatty acids impede the generation of suds. Soap is a salt of a fatty acid and has the general formula (RCO₂-⁻)ₙMⁿ⁺ (Where R is an alkyl, M is an alkali metal, earth alkali metal or any multivalent metal and n is the charge of the cation). The major classification of soaps is determined by the identity of Mⁿ⁺. For example, when M is Na (Sodium) or K (Potassium), the soaps are called toilet soaps, used for handwashing. Most preferably M is sodium in soaps.

Suitable anionic surfactants can be selected from the group consisting of: alkyl sulphate anionic surfactant, alkyl sulphonate anionic surfactant, alkyl sulphosuccinate and dialkyl sulphosuccinate ester surfactants, and mixtures thereof.

The anionic surfactant can comprise at least 70%, preferably at least 85%, more preferably 100% or different combinations of the upper and lower percentages described above or combinations of any value in the ranges listed above by weight of the anionic surfactant of alkyl sulphate anionic surfactant.

The mol average alkyl chain length of the alkyl sulphate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulphate anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulphate anionic surfactant can be derived from the carbon chain length distribution of the anionic surfactant. The carbon chain length distribution of the alkyl chains of the alkyl sulphate anionic surfactants can be obtained from the technical data sheets from the suppliers for the surfactant or constituent alkyl alcohol. Alternatively, the chain length distribution and average molecular weight of the fatty alcohols, used to make the alkyl sulphate anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulphate anionic surfactant should be hydrolysed back to the corresponding alkyl alcohol and alkyl alkoxylated alcohol before analysis, for instance using hydrochloric acid.

The alkyl sulphate surfactant can be alkoxylated or free of alkoxylation. When alkoxylated, the alkyl sulphate anionic surfactant can have an average degree of alkoxylation of less than 3.5, preferably from 0.3 to 2.0, more preferably from 0.5 to 0.9, in order to improve low temperature physical stability and improve suds mileage of the compositions of the present disclosure. When alkoxylated, ethoxylation is preferred.

The average degree of alkoxylation is the mol average degree of alkoxylation (i.e., mol average alkoxylation degree) of all the alkyl sulphate anionic surfactant. Hence, when calculating the mol average alkoxylation degree, the mols of non-alkoxylated sulphate anionic surfactant are included:

$$\begin{matrix}\text{Mol average aloxylation degree} = \left(x 1 * \text{alkoxylation degree}\right. \\ \text{of} \text{surfactant 1 + x2* alkoxylation degree of} \\ \left.\text{surfactant 2} + …\right) / \left(x 1 + x 2 + …\right)\end{matrix}$$

where x1, x2, ... are the number of moles of each alkyl (or alkoxy) sulphate anionic surfactant of the mixture and alkoxylation degree is the number of alkoxy groups in each alkyl sulphate anionic surfactant.

Preferred alkyl alkoxy sulphates are alkyl ethoxy sulphates.

The alkyl sulphate anionic surfactant can have a weight average degree of branching of from about 5% to about 60%, preferably 15% to 60%, more preferably from 20% to 60%.

The alkyl sulphate anionic surfactant can comprise at least 5%, preferably at least 10%, most preferably at least 25%, by weight of the alkyl sulphate anionic surfactant, of branching on the C2 position (as measured counting carbon atoms from the sulphate group for non-alkoxylated alkyl sulphate anionic surfactants, and the counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the liquid cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

$$\begin{matrix}\text{Weight average degree of branching} \left(\%\right) = \\ \left[\left(\text{x1*wt\% branched alcohol 1 in alcohol 1 +}\right.\right. \\ \left.\text{x2* wt\% branched alcohol 2 in alcohol 2 +} …\right) / \\ \left.\left(\text{x1+x2} \left.+ …\right)\right.\right] * 100\end{matrix}$$

where x1, x2, ... are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulphate anionic surfactant.

Suitable counterions include alkali metal cation earth alkali metal cation, alkanolammonium or ammonium or substituted ammonium, but preferably sodium.

Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulphate anionic surfactant, including grease cleaning, sudsing, low temperature stability and viscosity of the finished product. The alkoxylation distribution, including its broadness can be varied through the selection of catalyst and process conditions when making the alkoxylated alkyl sulphate anionic surfactant.

If ethoxylated alkyl sulphate is present, without wishing to be bound by theory, through tight control of processing conditions and feedstock material compositions, both during alkoxylation especially ethoxylation and sulphation steps, the amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulphates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N- methyl amino)-L-alanine, and mixtures thereof.

Anionic alkyl sulphonate or sulphonic acid surfactants suitable for use herein include the acid and salt forms of alkylbenzene sulphonates, alkyl ester sulphonates, primary and secondary alkane sulphonates such as paraffin sulfonates, alfa or internal olefin sulphonates, alkyl sulphonated (poly)carboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates especially C5-C20 methyl ester sulfonates, C6-C22 primary or secondary alkane sulphonates, C5-C20 sulphonated (poly)carboxylic acids, and any mixtures thereof, but preferably C11-C13 alkylbenzene sulphonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulphonates include paraffin sulphonates and other secondary alkane sulfonate (such as Hostapur SAS60 from Clariant).

Alkyl sulfosuccinate and dialkyl sulfosuccinate esters are organic compounds with the formula MO3SCH(CO2R')CH2CO2R where R and R′ can be H or alkyl groups, and M is a counterion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulphate anionic surfactant.

### Co-Surfactant

In order to improve surfactant packing after dilution and hence improve suds mileage, the surfactant system can comprise a co-surfactant. The co-surfactant can be selected from the group consisting of an amphoteric surfactant, a zwitterionic surfactant and mixtures thereof.

The anionic surfactant to the co-surfactant weight ratio can be from 1:1 to 8:1, from 1:1 to 5:1, from 1:1 to 3:1, from 1.3:1 to 2.2:1, or different combinations of the upper and lower ratios described above or combinations of any value in the ranges listed above.

The weight ratio of the nonionic surfactant to the co-surfactant can be from 8:1 to 1:1, from 5:1 to 2:1, from 4:1 to 2.5:1, or different combinations of the upper and lower ratios described above or combinations of any value in the ranges listed above.

The composition may comprise from 0.1% to 20%, from 0.5% to 15%, from 2% to 10% or different combinations of the upper and lower percentages described above or combinations of any value in the ranges listed above by weight of the composition by weight of the cleaning composition of the co-surfactant.

The surfactant system of the cleaning composition of the present disclosure preferably comprises up to 35%, preferably from 3% to 30%, more preferably from 5% to 25%, by weight of the surfactant system of a co-surfactant.

The co-surfactant may be selected from the group consisting of a betaine surfactant, an amine oxide surfactant, and mixtures thereof, preferably an amine oxide surfactant.

The amine oxide surfactant can be linear or branched, though linear are preferred. Suitable linear amine oxides are typically water-soluble and characterized by the formula R1 - N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants, in particular, may include linear C10-C18 alkyl dimethyl amine oxides and linear C8-C12 alkoxy ethyl dihydroxy ethyl amine oxides.

Preferably, the amine oxide surfactant is selected from the group consisting of alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, or mixtures thereof. C12-C14 alkyl dimethyl amine oxide is particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein, “symmetric” means that | n1 - n2 | is less than or equal to 5, preferably 4, most preferably from 0 to 4 carbon atoms in at least 50 wt%, more preferably at least 75 wt% to 100 wt% of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition may comprise:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof.

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine, and preferably meets formula (I):

$$\begin{matrix}\text{R1-} {\left[\text{CO-X} {\left(\text{CH2}\right)}_{\text{n}}\right]}_{\text{x}} {\text{-N}}^{+} \left(\text{R2}\right) \left(\text{R3}\right) \text{-} {\left({\text{CH}}_{2}\right)}_{m} \text{-} \\ {\left[\text{CH} \left(\text{OH}\right) {\text{-CH}}_{2}\right]}_{\text{y}} \text{-Y-}\end{matrix}$$

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S, n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl, m is an integer from 1 to 4, preferably 1, 2 or 3,
y is 0 or 1, and
Y is selected from the group consisting of: COO, SO₃, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaine of formula (Ic) and the amido sulphobetaine of formula (Id):

$${\text{R1-N}}^{+} {\left({\text{CH}}_{3}\right)}_{2} - {\text{CH}}_{2} \text{COO-}$$

$$\text{R1-CO-NH-} {\left({\text{CH}}_{2}\right)}_{3} {\text{-N}}^{+} {\left({\text{CH}}_{3}\right)}_{2} {\text{-CH}}_{2} \text{-COO-}$$

$${\text{R1-N}}^{+} {\left({\text{CH}}_{3}\right)}_{2} {\text{-CH}}_{2} \text{CH} \left(\text{OH}\right) {\text{CH}}_{2} {\text{SO}}_{\text{3}} {}^{\text{-}}$$

$$\text{R1-CO-NH-} {\left({\text{CH}}_{\text{2}}\right)}_{\text{3}} {\text{-N}}^{\text{+}} {\left({\text{CH}}_{\text{3}}\right)}_{\text{2}} {\text{-CH}}_{\text{2}} \text{CH} \left(\text{OH}\right) {\text{CH}}_{\text{2}} {\text{SO}}_{\text{3}} {}^{\text{-}}$$

in which R1 has the same meaning as in formula (I). Particularly preferred are the carbobetaines [i.e., where Y=COO in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine / amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Further Ingredients

The composition can comprise further ingredients such as those selected from: amphiphilic alkoxylated polyalkyleneimines, cyclic polyamines, triblock copolymers, hydrotropes, organic solvents, other adjunct ingredients such as those described herein, and mixtures thereof.

### Amphiphilic Alkoxylated Polyalkyleneimine

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

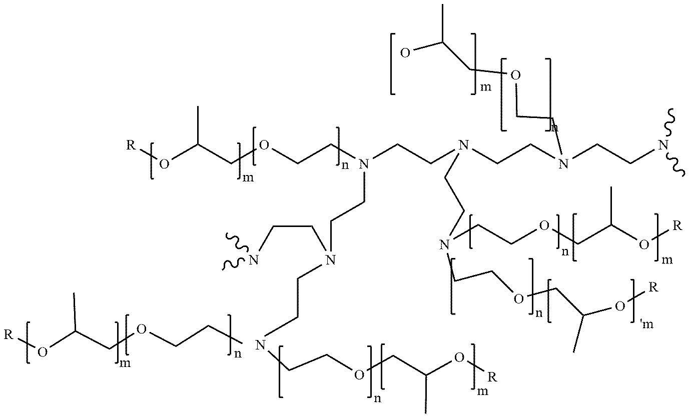

where the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the compositions can be free of amphiphilic polymers.

### Cyclic Polyamine

The composition can comprise a cyclic polyamine having amine functionalities that helps cleaning. The composition of the disclosure preferably comprises from 0.1% to 3%, more preferably from 0.2% to 2%, and especially from 0.5% to 1%, by weight of the total composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is -CH3 and the rest are H provided for improved grease cleaning performance.

Accordingly, the most preferred cyclic polyamine for use with the cleaning composition of the present disclosure are cyclic polyamine selected from the group consisting of 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulphate is particularly preferred. As such, the composition can further comprise magnesium sulphate at a level of from 0.001 % to 2.0 %, preferably from 0.005 % to 1.0 %, more preferably from 0.01 % to 0.5 % by weight of the composition.

### Triblock Copolymer

The composition of the disclosure can comprise a triblock copolymer. The triblock <SHY> polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO)ₓ(PO)_{y}(EO)ₓ, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames PluronicOO PE6400 (MW ca 2900, ca 40 wt% EO) and Pluronic® PE 9400 (MW ca 4600, 40 wt% EO). Particularly preferred triblock co-polymer from the Dow Chemical Company is sold under the tradename Tergitol™ L64 (MW ca 2700, ca 40 wt% EO).

Preferred triblock co-polymers are readily biodegradable under aerobic conditions.

### Salt, Hydrotrope, Organic Solvent

The composition of the present disclosure may further comprise at least one active selected from the group consisting of: i) a salt, ii) a hydrotrope, iii) an organic solvent, and mixtures thereof.

### i) Salt

The composition of the present disclosure may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

### ii) Hydrotrope

The composition of the present disclosure may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

### iii) Organic Solvent

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg- ions, antibacterial agents, preservatives, viscosity adjusters (e.g., salt such as NaCl, and other mono-, di- and trivalent salts) and pH adjusters and buffering means (e.g. carboxylic acids such as citric acid, HC1, NaOH, KOH, alkanolamines, carbonates such as sodium carbonates, bicarbonates, sesquicarbonates, and alike).

The cleaning composition may further comprise citric acid or a salt thereof, preferably in an amount of from 0.25% to 5%, from 0.35% to 4%, or from 0.5% to 2.0% by weight of the composition, preferably the salt of citric acid is selected from the group consisting of: sodium, potassium, aluminum, ammonium, ferric, magnesium, or zinc salts of citric acid, and mixtures thereof, more preferably the salt of citric acid is a sodium salt of citric acid. Without wishing to be bound by theory, providing a salt of citric acid, preferably a sodium salt of citric acid in the above ranges in a cleaning composition provides improved surfactant dissolution.

### Packaged Product

The liquid hand dishwashing cleaning composition can be packaged in a container, typically plastic containers. Suitable containers comprise an orifice. Typically, the container comprises a cap, with the orifice typically comprised on the cap. Preferably, the hand dishwashing cleaning composition can be packaged in a liquid dispenser for releasably affixing to an inverted container containing dispensable liquid (see for example, a liquid dispenser disclosed in EP Patent No. 3492400A1, published on 5 Jun. 2019).

The container can typically comprise from 200 ml to 5,000 ml, preferably from 350 ml to 2000 ml, more preferably from 400 ml to 1,000 ml of the liquid hand dishwashing detergent composition.

### Method of Manufacturing

Another embodiment of the present disclosure is directed to a method of manufacturing a composition. The method comprises:
i) mixing a first nonionic surfactant wherein the first nonionic surfactant is an alkyl polyglucoside surfactant, and a hydrotrope to form a premix.
ii) using the premix to form the composition, preferably using the premix comprises adding the premix to an intermediate detergent stream and mixing the premix with an anionic surfactant, a co-surfactant, and a second nonionic surfactant and further optional materials in the intermediate detergent stream to form the composition;
wherein the hydrotrope is selected from sodium, potassium, and ammonium xylene sulfonate, sodium, potassium and ammonium toluene sulfonate, sodium potassium and ammonium cumene sulfonate, and mixtures thereof, preferably sodium cumene sulfonate.

### Process of Cleaning/Treating a Dishware

Another embodiment of the present disclosure is directed to a process of cleaning dishes with a composition of the present disclosure. The process comprises the step(s) of applying the composition onto the dish surface, typically in diluted or neat form, and rinsing the dish. The process may comprise the step of applying the composition in neat form onto a sponge and contacting the sponge containing the composition on the dish surface.

In one embodiment of the present disclosure, the composition herein can be applied in its diluted form. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface. The contacting of cloth, sponge, or similar article to the dish surface is preferably accompanied by a concurrent scrubbing of the dish surface.

Another method of the present disclosure will comprise immersing the soiled dishes into a water bath or held under running water without any liquid dishwashing detergent. A device for absorbing liquid dishwashing detergent, such as a sponge, is placed directly into a separate quantity of undiluted liquid dishwashing composition. The absorbing device, and consequently the undiluted liquid dishwashing composition, is then contacted individually to the surface of each of the soiled dishes to remove said soiling. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting the hand dishwashing composition with water in a small container that can accommodate the cleaning device.

In one embodiment, a method of cleaning a dish with a liquid dish detergent composition described herein, said method comprising the steps of applying the composition onto the dish or in a dish washing basin or a dish cleaning implement. In another embodiment, the use of a composition described herein is used to achieve a plurality of benefits on a target surface, preferably wherein the target surface is a dish, wherein the plurality of benefits comprises grease cleaning, suds mileage, flash suds.

The following examples are intended to more fully illustrate the present disclosure and are not to be construed as limitations of the present disclosure since variations thereof are possible without departing from the scope of the present disclosure. All parts, percentages and ratios used herein are expressed as percent weight unless otherwise specified.

### EXAMPLES

Test Methods are first described and then liquid hand dishwashing cleaning compositions which are assessed according to the Test Methods are described under Example Liquid Cleaning Compositions, and lastly results are discussed. Data is provided demonstrating the liquid hand dishwashing cleaning compositions of the present disclosure have improved ability to build initial suds when applied neat to a sponge, to maintain its suds volume throughout a washing cycle and to effectively remove grease, as well as exhibiting phase stability upon ageing.

### TEST METHODS

### (I) Test Method for Evaluating Low Temperature (5° C.) Stability

This test method is to evaluate stability of a liquid hand dishwashing cleaning composition at low temperature, 5° C. and is performed according to the following steps.
1. 3 closed PET (100 ml) stability bottles (= 3 replicates) comprising 60 g of a test composition per bottle are placed together with 6 empty closed PET bottles in a 5° C. constant temperature stability room.
2. After 24 hour the samples are visually inspected for absence of physical instability (phase separation, cloudiness, precipitation).
3. If free from physical instability the samples are poured over in an empty PET bottle, closed and vigorously shaken 5 times and stored for another 24 hour prior to a visual re-inspection for absence of physical instability.
4. Step (3), the pouring over step is repeated on day 3 followed by a final visual inspection on day 4 for physical instability.
5. Samples are reported as a pass in case no signs of physical instability are observed in either of the replicate samples after day 4.

### (II) Test Method for Evaluating Phase Stability @RT (Room Temperature)

100ml samples are stored overnight after making in closed glass vials at room temperature (e.g. 20° C.) and then visually inspected for absence of physical instability. (phase separation, cloudiness, precipitation).

### (III) Test Method for Evaluating Grease Cleaning Performance

The grease cleaning performance test method is used to measure the relative grease removal performance of liquid hand dishwashing test products across different product concentrations / water hardness / temperature conditions (here : 2dH, 35° C., product concentration : 0.5%, 1%, 1.5%, 5%, 10%) versus a liquid hand dishwashing reference product.

The method includes the application of pre-heated (50° C. oven for 2h) homogenized Lard soil #44069 supplied by Warwick Equest Ltd. UK on a Polypropylene non-woven substrate (60 g/m2 Spunbond-Meltblown-Spunbond Nonwoven produced by Avgol) using a stain printer (Custom robotic platform by FLAMAC, Belgium), followed by allowing the stains to dry for 24 hr at 21° C. Wash solutions are prepared at targeted finished product concentrations, water hardness and temperature and are consequently contacted with the stained polypropylene substrate for 10 minutes using a 96-channel pipetting head and a well plate (950uL wash volume per well) positioned on top of the soiled substrate.

4 rinse cycles (950 uL rinse water of 2 dH water hardness, 35° C.) are applied per well post the wash cycle, followed by drying the washed substrate for 24 hr at 30° C. Wash and rinse solutions are removed from the wells after the wash and rinse cycles using a 96-channel pipetting head. Stain intensity is measured before and after the treatment through imaging using a Digi-Eye by Verivide UK, Z02791) and analyzed using an “Automated HTe Image Analysis” tool, and washing efficacy results are consequently expressed as a %SRI (Stain Removal Index - the higher the better). The %SRI results of 8 replicates per test condition are averaged and consequently plotted in a linear %SRI versus product concentration plot. The area under the resulting curve is calculated and indexed versus the area under the curve of a reference product. The % SRI Index is calculated by comparing the area under the curve of the test composition sample versus the area under the curve of the reference composition sample (e.g. Kao’s marketed dishwashing product: CCT CL 2020. CDB _211112_002). The calculation is as follows:

$$\% \text{SRI Index} = \frac{\begin{matrix}\text{Area under the curve} \\ \text{of test composition}\end{matrix}}{\begin{matrix}\text{Area under the curve} \\ \text{of reference composition}\end{matrix}} \times 100$$

### (IV) Test Method for Suds Mileage

The objective of the Suds Mileage Test is to compare the evolution over time of suds volume generated for the test formulations at various water hardness, solution temperatures and formulation concentrations, while under the influence of periodic additions of soil. Data are compared and expressed versus a reference composition as a suds mileage index (reference composition has a suds mileage index of 100). The steps of the method are as follows:
1. A rectangular metal blade having a horizontal length of 100 mm and vertical height of 50 mm is positioned in a sink having dimension of circa 300 mm diameter and circa 300 mm height, such that the blade is positioned centrally in the sink, with the top of the blade level with the surface of wash solution when 4 L of the wash solution is added to the sink. The blade is mounted on a vertical axis of length 85 mm. The top of the vertical axis is mounted to a second axis at an angle of 60° to the vertical, the second axis being connected to a rotation device such that the blade rotates in a plane tilted 30 ° from the vertical position.
2. A fixed amount (4.8 g) of the test composition is dispensed through a plastic pipette at a flow rate of 0.67 mL/ sec at a height of 37 cm above the bottom surface of a sink having dimension of circa 300 mm diameter and circa 300 mm height), into a stream of water of water hardness: 2 dH (11.21 gpg) and temperature 35° C. that is filling up the sink at a flow rate of 8 L/min from a tap having an M24 perlator (aerator) and a constant water pressure of 4 bar, so that 4 L of resulting wash solution is delivered to the wash basin, having a detergent concentration of 0.12 wt%. Dispensing of the test composition is started 1 second after the start of dispensing of the water stream.
3. An initial suds volume generated (measured from the average height of the foam in the sink surface and expressed in cm³ of foam (i.e. suds volume)) is recorded immediately after the end of filling.
4. The wash solution is agitated using the blade, rotating continually for 20 revolutions at 85 RPM. A fixed amount (6 mL) of a greasy or particulate soil (see Tables 1 and 2 below) is injected into the middle of the sink during the 10^{th} rotation of the blade, such that there are 10 revolutions of the blade after addition of the soil.
5. Another measurement of the total suds volume is recorded immediately after end of blade rotation.
6. Steps 4-5 are repeated such that there is a 3-minute interval between soil additions, until the measured total suds volume reaches a minimum level of 400 cm³. The amount of added soil that is needed to arrive at the 400 cm³ level is considered as the suds mileage for the test composition.
7. Each test composition is tested 4 times per testing condition (i.e., water temperature, composition concentration, water hardness, soil type) and the average suds mileage is calculated as the average of the 4 replicates.
8. The Suds Mileage Index is calculated by comparing the average mileage of the test composition sample versus the reference composition sample (e.g. Kao’s marketed dishwashing product: CCT CL 2020. CDB_211112_002). The calculation is as follows:

$$\text{Suds Mileage Index} = \frac{\begin{matrix}\text{Average number of soil additions} \\ \text{of test composition}\end{matrix}}{\begin{matrix}\text{Average number of soil additions} \\ \text{of reference composition}\end{matrix}} \times 100$$

The soil compositions are produced through standard mixing of the components described in Table 1.

Table 1

Particulate Soil

| Ingredient | Weight % |
|---|---|
| Zwan Flemish Carbonades | 22.67 |
| Beaten Eggs | 4.78 |
| Smash Instant Mash Potato | 9.26 |
| McDougall’s Sponge Mix | 3.30 |
| Milk UHT Full Cream | 22.22 |
| Bisto Gravy Granules | 1.30 |
| Mazola^{®} Pure Corn Oil | 9.29 |
| Demineralized water | 26.32 |
| Sodium Benzoate | 0.42 |
| Potassium Sorbate | 0.42 |

### (V) Test Method for Evaluating Flash Suds Performance

This test is to technically generate initial(flash) suds with the use of a Universal Robotics arm and a custom designed sponge compressor to evaluate sudsing potential of liquid hand dishwashing detergent products when applied neat on a wet sponge and squeezed.

The test includes 4 replicates per test product and is performed according to the following steps:
1. 1 ml of a preloaded liquid dish washing test product is applied from a syringe upright onto the center area (yellow side upwards, green side downwards) of a pre-soaked brand new sponge (½ size Sumitomo 3M 2-layer sponge, Japan - dimensions: 7.5 × 5.75 × 3.0 cm, Type: Code S-21 K, Material =Nylon for scrubber, urethane for sponge material) containing 25 g of water (2-3 gpg water hardness, 28° C. +/- 2° C.).
2. The product is allowed to be absorbed into the sponge for 3 seconds.
3. The sponge is then inverted (green side up) and placed directly under the robot arm gripper.
4. The automated sponge compressor consequently compresses the sponge, using a horizontal plate covering the entire sponge top surface, 9 times from the top till a remaining sponge height of 12 mm from the top at a compressing rate of 12 mm / 250 ms, sustaining each compression for 1.5 seconds, instant relaxing followed by re-compressing the sponge after another 1.5 seconds.
5. The amount of suds created is collected in a volumetric cone using a spatula and the total volume of foam generated (in ml) is measured and averaged across replicates (the higher the better).
6. The measured total volume of foam (mL) is used to assess initial(flash) suds generated by the product, the initial(flash) suds corresponding to a Flash Suds performance of the product.

### EXAMPLE LIQUID CLEANING COMPOSITIONS

Table 1 describes the example liquid cleaning compositions which are evaluated for their ability to build initial suds when applied neat to a sponge, to maintain their suds volume throughout a washing cycle and to effectively remove grease, as well as their phase stability upon ageing.

Inventive Composition 1 (shown as Ex. 1 in Table 1) and Comparative Compositions A, B, C and D (shown respectively in Table 1 as Ex. A, Ex. B, Ex. C, Ex. D) are produced through standard mixing of the components described in Table 1. Inventive Composition 1 differs from the Comparative Compositions A, B, C and D respectively by having:
1) a lower level of nonionic surfactants, in an amount of 14.2% by weight of the composition, i.e. less than a level of nonionic surfactants in the Comparative Composition A (19%)
2) a higher weight ratio of total level of nonionic surfactants to anionic surfactant of 1.5: 1, i.e. within the weight ratio of from 1:1 to 3:1, relative to Comparative Composition B
3) a mixture of first and second nonionic surfactants (alkyl polyglucoside surfactant and an alkyl ethoxylated alcohol nonionic surfactant in an amount of 14.2% by weight of the composition relative to Comparative Composition C (having a single nonionic surfactant (alkyl polyglucoside surfactant) in an amount of 14.2% by weight of the composition) and Comparative Composition D (having a single nonionic surfactant (an alkyl ethoxylated alcohol nonionic surfactant) in an amount of 14.2% by weight of the composition.

Table 1

Inventive Composition and Comparative Compositions

| Ingredients (% by weight of the composition - 100% active basis) | Chemical name (Trade name) | Ex. 1 | Ex. A | Ex. B | Ex. C | Ex. D |
|---|---|---|---|---|---|---|
| First nonionic surfactant (First NI)* | Alkyl polyglucoside (added as a pre-mix of Glucopon® 600 by BASF and sodium cumene sulphonate*) | 7.1 | 9.5 | 4.75 | 14.2 | 0 |
| Second nonionic surfactant (Second NI) | C12Alkyl ethoxylated nonionic surfactant (Neodol 91/8¹ by Shell) | 7.1 | 9.5 | 4.75 | 0 | 14.2 |
| Anionic Surfactant (AN) | Alkyl ethoxy sulfate² (AES) | 9.5 | 6.3 | 12.6 | 9.5 | 9.5 |
| Fatty Acid or Salts (Soap) | Soap | 0 | 0 | 0 | 0 | 0 |
| Co-Surfactant (Amphoteric surfactant) | Amine Oxide³ (AO) | 4.7 | 3.1 | 6.3 | 4.7 | 4.7 |
| Total Surfactant System | | 28.4 | 28.4 | 28.4 | 28.4 | 28.4 |

¹ C9 to C11 alcohol ethoxylate

² the alkyl sulfate anionic surfactant is an alkyl ethoxy sulfate comprising 12 to 13 carbon atoms with an average degree of ethoxylation of 0.7 (C1213AE0.7S)

³ Linear C12-14 dimethyl amine oxide

| Ingredients (% by weight of the composition - 100% active basis) | Chemical name (Trade name) | Ex. 1 | Ex. A | Ex. B | Ex. C | Ex. D |
|---|---|---|---|---|---|---|
| (total amount of surfactants) | | | | | | |
| Wt% of First NI, Second NI in the Total Surfactant System | | 25.0; 25.0 | 33.45; 33.45 | 16.725; 16.725 | 50.0; 0 | 0; 50.0 |
| Wt% of NI, AES, AO in the Total Surfactant System | | 50.0; 33.5; 16.5 | 66.9; 22.2; 10.9 | 33.45; 44.45; 22.1 | 50.0; 33.5; 16.5 | 50.0 33.5 16.5 |
| NI (First NI + Second NI):AN weight ratio | | 1.5:1 | 3:1 | 1:1.3 | 1.5:1 | 1.5:1 |
| First NI: Second NI weight ratio | | 1:1 | 1:1 | 1:1 | | |
| AES:AO weight ratio | | 2:1 | 2:1 | 2:1 | 2:1 | 2:1 |
| MgCl2 | | 0.2 | 0.2 | 0.2 | 0.2 | 0.2 |
| Sodium citrate | | 0.85 | 0.85 | 0.85 | 0.85 | 0.85 |
| Sodium cumene sulphonate | | 2.25 | 2.25 | 2.25 | 2.25 | 2.25 |
| Ethanol (viscosity trimming agent) | | 2.0 | 1.0 | 1.0 | 2.0 | 0.0 |
| PPG (MW 2000) (secondary viscosity trimming agent) | | 0.1 | 0.1 | 0.1 | 0.1 | 0.0 |
| Baxxodur ECX210 | | 0.2 | 0.2 | 0.3 | 0.2 | 0.2 |
| Acticide M20 | | 0.0075 | 0.0075 | 0.0075 | 0.0075 | 0.0075 |
| Phenoxyethanol | | 0.08 | 0.08 | 0.08 | 0.08 | 0.08 |
| Perfume | | 0.95 | 0.95 | 0.95 | 0.95 | 0.95 |
| Dye | | 0.0007 | 0.0007 | 0.0007 | 0.007 | 0.007 |
| Water | | Balance to 100 | Balance to 100 | Balance to 100 | Balance to 100 | Balance to 100 |
| Total amount | | 100 | 100 | 100 | 100 | 100 |
| Viscosity at 20° C. | | 160 cps | 160 cps | 160 cps | 160 cps | 160 cps |
| pH at 20° C. (10% solution) | | 7.8 | 7.8 | 7.8 | 7.8 | 7.8 |

* Sodium cumene sulphonate (as reflected in compositions above) may be added to alkyl polyglucoside surfactant to form a premix prior to adding to other surfactants and ingredients in the composition to improve solubility and reduce viscosity in processing and manufacturing of the liquid cleaning compositions. Detailed composition: Glucopon 683® by BASF, e.g. 80/30 mixture by weight of Glucopon® 600 by BASF and 40% active sodium cumene sulphonate aqueous solution. Glucopon 683® by BASF is a C12-C14 alkyl polyglucoside.

Alternatively, sodium xylene sulphonate or sodium toluene sulphonate can be used as alternative materials to sodium cumene sulphonate. Glucopon® 625 by BASF can be used as an alternative for Glucopon® 600 by BASF.

Example 1: Inventive Composition comprising a weight ratio of nonionic surfactant to anionic surfactant of 1.5:1 and the nonionic surfactant is 14.2% by weight of the composition, and Comparative Compositions

Inventive Composition 1 and Comparative Compositions A and B in Table 1 are assessed according to the Test Methods for storage stability, flash suds, suds mileage and grease cleaning benefits. Results for the Inventive Composition 1 and Comparative Compositions A and B are illustrated in Table 2 below.

Table 2

Results of Inventive and Comparative Compositions

| Inventive/ Comparative Compositions | Phase stability @ low temperature (5° C.) | Phase stability @Room Temperature (20° C.) | Grease Cleaning Performance (Index Score) | Suds Mileage Performance (Index Score) | Flash Suds Performance (mL of foam generated) |
|---|---|---|---|---|---|
| Ex. 1 | pass | clear | 98 | 121 | 154 |
| Ex. A | pass | clear | 61 | 109 | 120 |
| Ex. B | N/A as there is already a phase split at RT | Phase split | 100 | 120 | 101 |

From the above results in Table 2, Inventive Composition 1 has the best performance results for all the assessed benefits, i.e. overall flash suds superiority (score of 154), exhibiting stability in low temperature, no phase split at room temperature, and achieving excellent suds mileage (score of 121) and grease cleaning results (score of 98). The Inventive Composition 1 has the highest flash suds score relative to Comparative Compositions A, B. In addition, Comparative Compositions A, B showed mixed results for all the assessed benefits as described hereinafter.

Comparative Composition A, having the nonionic surfactant at a level of 19% by weight of the composition, has overall poorer suds mileage, grease cleaning results, and flash suds results relative to Inventive Composition 1 based on the lower scores despite exhibiting stability in low temperature and no phase split at room temperature.

Comparative Composition B has the nonionic surfactant at a level of 8.5% by weight of the composition but has more anionic surfactant than nonionic surfactant, i.e. having a weight ratio of nonionic surfactant to anionic surfactant of 1:1.3 (less than 1:1). The results for Comparative Composition B having a weight ratio of nonionic surfactant to anionic surfactant of less than 1:1 show poor stability in low temperature and there is a phase split at room temperature, and poorer flash suds results relative to Inventive Composition 1 despite having similar suds mileage and grease cleaning results as Inventive Composition 1.

In summary, an inventive composition free of fatty acid or salts thereof and having a NI:AN ratio of from 1:1 to 3:1 and a total level of nonionic surfactants of from 5% to 18.4% by weight of the composition according to the present disclosure demonstrates superior performance for all the assessed benefits desired by users.

Example 2: Inventive Composition comprising a mixture of nonionic surfactants and Comparative Compositions

Inventive Composition 1 and Comparative Compositions C and D in Table 1 are assessed according to the Test Methods for storage stability, flash suds, suds mileage and grease cleaning benefits. Results for the Inventive Composition 1 and Comparative Compositions C and D are illustrated in Table 3 below.

Table 3 -

Results of Inventive and Comparative Compositions

| Inventive/ Comparative Compositions | Phase stability @ low Temperature (5° C.) | Phase stability @RT (20° C.) | Grease Cleaning Performance Index | Suds Mileage Performance | Flash Suds Performance (mL of foam generated) |
|---|---|---|---|---|---|
| Ex. 1 | Pass | Clear | 100 | 121 | 154 |
| Ex. C | Pass | Clear | 79 | 115 | 155 |
| Ex. D | Pass | Clear | 102 | 118 | 111 |

From the above results in Table 3, Inventive Composition 1 having a mixture of first and second nonionic surfactants, i.e. alkyl polyglucoside surfactant and alkoxylated alcohol nonionic surfactant, demonstrates the best performance results for all the assessed benefits, i.e. overall flash suds superiority (score of 154), exhibiting stability in low temperature, no phase split at room temperature, and achieving excellent suds mileage (score of 121) and grease cleaning results (score of 98). On the other hand, the Comparative Compositions C, D did not pass the success criteria required for all the assessed benefits as described hereinafter.

Comparative Compositions C and D, respectively having a single nonionic surfactant, show stability in low temperature, no phase split at room temperature. However, Comparative Composition C having a single nonionic surfactant, i.e. an alkyl polyglucoside surfactant, exhibits overall poorer suds mileage, and poor grease cleaning results relative to Inventive Composition 1 based on the lower scores. Comparative Composition D having a single nonionic surfactant, i.e. an alkyl ethoxylated alcohol nonionic surfactant also exhibits poorer flash suds results relative to Inventive Composition 1.

Example 3: Inventive Composition 2 comprising a weight ratio of nonionic surfactant to anionic surfactant of 1.5: 1 and the nonionic surfactant is 14.2% by weight of the composition, and Comparative Compositions - similar to example 1 but using alternative anionic surfactant -amphoteric co-surfactant chemistry

Table 4 describes the example liquid cleaning compositions which are evaluated for their ability to build initial suds when applied neat to a sponge, to effectively remove grease, as well as their phase stability upon ageing. The compositions are similar to the ones displayed in Table 1 but using a different anionic surfactant - amphoteric co-surfactant chemistry, more particularly the AES anionic surfactant has been replaced using a sodium linear dodecyl Propoxy (1) Sulphate (APS) / sodium dioctyl sulfosuccinate (Geropon SDS / AOT) mixed anionic surfactant system in a 5 to 1 weight ratio, while the AO has been replaced using a lauryl hydroxysulfobetaine surfactant.

Inventive Composition 2 (shown as Ex. 2 in Table 4) and Comparative Compositions E and F (shown respectively in Table 4 as Ex. E, Ex. F) are produced through standard mixing of the components described in Table 4. Inventive Composition 2 differs from the Comparative Compositions E and F respectively by having:
1) a lower level of nonionic surfactants, in an amount of 14.2% by weight of the composition, i.e. less than a level of nonionic surfactants in the Comparative Composition E (19%)
2) a higher weight ratio of total level of nonionic surfactants to anionic surfactant of 1.5:1, i.e. greater than 1:1, relative to Comparative Composition F

Table 4 -

Inventive Composition 2 and Comparative Compositions

| Ingredients (% by weight of the composition - 100% active basis) | Chemical name (Trade name) | Ex. 2 | Ex. E | Ex. F |
|---|---|---|---|---|
| First nonionic surfactant (First NI)* | Alkyl polyglucoside (added as a pre-mix of Glucopon® 600 by BASF and sodium cumene sulphonate*) | 7.1 | 9.5 | 4.75 |
| Second nonionic surfactant (Second NI) | Alkyl ethoxylated nonionic surfactant (Neodol 91/8⁴ by Shell) | 7.1 | 9.5 | 4.75 |
| Anionic Surfactant (AN) | Lin. C12 propoxy (1) sulfate⁷ (APS) sodium dioctyl sulfosuccinate (AOT) (5:1-weight ratio) | 9.5 | 6.3 | 12.6 |
| Fatty Acid or Salts Thereof (Soap) | Soap | 0 | 0 | 0 |
| Co-Surfactant (Amphoteric surfactant) | lauryl hydroxysulfobetaine(Mack am LHS)⁸ | 4.7 | 3.1 | 6.3 |
| Total Surfactant System (total amount of surfactants) | | 28.4 | 28.4 | 28.4 |
| Wt% of First NI, Second NI in the Total Surfactant System | | 25.0; 25.0 | 33.45; 33.45 | 16.725; 16.725 |
| Wt% of NI, AN, amphoteric in the Total Surfactant System | | 50.0; 33.5; 16.5 | 66.9; 22.2; 10.9 | 33.45; 44.45; 22.1 |
| NI (First NI + Second NI):AN weight ratio | | 1.5:1 | 3:1 | 1:1.3 |
| First NI: Second NI weight ratio | | 1:1 | 1:1 | 1:1 |
| AN: amphoteric weight ratio | | 2:1 | 2:1 | 2:1 |
| MgC12 | | 0.2 | 0.2 | 0.2 |
| Sodium citrate | | 0.85 | 0.85 | 0.85 |
| Sodium cumene sulphonate | | 2.25 | 2.25 | 2.25 |

⁴ C9 to C11 alcohol ethoxylate

| Ingredients (% by weight of the composition - 100% active basis) | Chemical name (Trade name) | Ex. 2 | Ex. E | Ex. F |
|---|---|---|---|---|
| Ethanol (viscosity trimming agent) | | 2.0 | 1.0 | 1.0 |
| PPG (MW 2000) (secondary viscosity trimming agent) | | 0.1 | 0.1 | 0.1 |
| Baxxodur ECX210 | | 0.2 | 0.2 | 0.3 |
| Acticide M20 | | 0.0075 | 0.0075 | 0.0075 |
| Phenoxyethanol | | 0.08 | 0.08 | 0.08 |
| Perfume | | 0.95 | 0.95 | 0.95 |
| Dye | | 0.0007 | 0.0007 | 0.0007 |
| Water | | Balance to 100 | Balance to 100 | Balance to 100 |
| Total amount | | 100 | 100 | 100 |
| Viscosity at 20° C. | | 109 cps | 112 cps | 98 cps |
| pH at 20° C. (10% solution) | | 7.8 | 7.8 | 7.8 |

* Sodium cumene sulphonate (as reflected in compositions above) may be added to alkyl polyglucoside surfactant to form a premix prior to adding to other surfactants and ingredients in the composition to improve solubility and reduce viscosity in processing and manufacturing of the liquid cleaning compositions. Detailed composition: Glucopon 683® by BASF, e.g. 80/30 mixture by weight of Glucopon® 600 by BASF and 40% active sodium cumene sulphonate aqueous solution. Glucopon 683® by BASF is a C12-C14 alkyl polyglucoside.

Alternatively, sodium xylene sulphonate or sodium toluene sulphonate can be used as alternative materials to sodium cumene sulphonate. Glucopon® 625 by BASF can be used as an alternative for Glucopon® 600 by BASF.

Inventive Composition 2 and Comparative Compositions E and F in Table 4 are assessed according to the Test Methods for storage stability, flash suds and grease cleaning benefits. Results for the Inventive Composition 2 and Comparative Compositions E and F are illustrated in Table 5 below.

Table 5-

Results of Inventive and Comparative Compositions

| Inventive/ Comparative Compositions | Phase stability @ low temperature (5° C.) | Phase stability @Room Temperature (20° C.) | Flash Suds Performance (mL of foam generated) |
|---|---|---|---|
| Ex. 2 | pass | clear | 113 |
| Ex. E | pass | clear | 108 |
| Ex. D | hazy | clear | 104 |

From the above results in Table 5, Inventive Composition 2 provides overall flash suds superiority (score of 113) while exhibiting phase stability across temperature. While the overall benefit is less when compared relative to an AES-AO comprising surfactant system, the same significant data trend is observed between the inventive composition 2 and respective comparative compositions E and F outside the scope of the present composition, showing the observed benefit to be valid across different anionic and amphoteric surfactant type systems. The Inventive Composition 2 has also shown superior grease cleaning performance relative to Comparative Composition E and superior phase stability profile versus Comparative Composition F.

In summary, an inventive composition having a NI:AN ratio of greater than 1:1 and a total level of nonionic surfactants of from 5% to 18.4% by weight of the composition according to the present disclosure demonstrates superior performance for all the assessed benefits desired by users, as shown for different anionic surfactant (AES, APS, AOT) and amphoteric co-surfactant (AO, alkylsulfobetaine) systems.

Without wishing to be bound by theory, Inventive Compositions 3 to 5 having a NI:AN ratio from 1:1 to 1.16:1, a nonionic surfactant mixture in a level of from 9.2% to 11% by weight of the composition also demonstrate superior performance benefits as described hereinbefore. The details of the Inventive Compositions 3 to 5 are described in Table 6 below.

Table 6–

Inventive Compositions 3 to 5

| Ingredients (% by weight of the composition - 100% active basis) | Chemical name (Trade name) | Inventive Ex. 3 | Inventive Ex. 4 | Inventive Ex. 5 |
|---|---|---|---|---|
| First nonionic surfactant (First NI)* | Alkyl polyglucoside (added as a pre-mix of Glucopon® 600 by BASF and sodium cumene sulphonate*) | 4.8 | 5.6 | 5.5 |
| Second nonionic surfactant (Second NI) | C12Alkyl ethoxylated nonionic surfactant (Neodol 91/8⁵ by Shell) | 4.4 | 4.8 | 5.5 |
| Anionic Surfactant (AN) | Alkyl ethoxy sulfate⁶ (AES) | 9.2 | 9.2 | 9.5 |
| Fatty Acid or Salts thereof | Soap | 0 | 0 | 0 |
| Co-Surfactant (Amphoteric surfactant) | Amine Oxide⁷ (AO) | 5.2 | 4.4 | 4.3 |
| Total Surfactant System (total amount of surfactants) | | 23.7 | 24.0 | 24.9 |
| NI (First NI + Second NI):AN weight ratio | | 1:1 | 1.13:1 | 1.16:1 |
| First NI: Second NI weight ratio | | 1.08:1 | 1.175:1 | 1:1 |
| AES:AO weight ratio | | 1.77:1 | 2.1:1 | 2.22:1 |
| MgC12 | | 0.6 | 0.6 | 0.6 |
| Sodium citrate | | 0.85 | 0.85 | 0.85 |
| Sodium cumene sulphonate | | 2.6 | 2.3 | 2.3 |
| Ethanol (viscosity trimming agent) | | 1.9 | 1.2 | 1.3 |

⁵ C9 to C11 alcohol ethoxylate
⁶ the alkyl sulfate anionic surfactant is an alkyl ethoxy sulfate comprising 12 to 13 carbon atoms with an average degree of ethoxylation of 0.7 (C1213AE0.7S)
⁷ Linear C12-14 dimethyl amine oxide

| Ingredients (% by weight of the composition - 100% active basis) | Chemical name (Trade name) | Inventive Ex. 3 | Inventive Ex. 4 | Inventive Ex. 5 |
|---|---|---|---|---|
| Baxxodur ECX210 | | 0.215 | 0.213 | 0.221 |
| MIT | | 0.01 | 0.01 | 0.01 |
| Phenoxy ethanol | | 0.15 | 0.15 | 0.15 |
| Perfume | | 0.3 | 0.3 | 0.3 |
| Dye | | 0.0008 | 0.0008 | 0.0008 |
| Water | | Balance to 100 | Balance to 100 | Balance to 100 |
| Total amount | | 100 | 100 | 100 |
| Viscosity at 20° C. | | 160 cps | 160 cps | 160 cps |
| pH at 20° C. (10% solution) | | 7.8 | 7.8 | 7.8 |

As described hereinbefore in the present disclosure, providing a liquid hand dishwashing cleaning composition comprising from 15% to 40% by weight of the composition of a surfactant system, the surfactant system having an anionic surfactant, a co-surfactant and a nonionic surfactant, wherein the composition comprises a weight ratio of the nonionic surfactant to the anionic surfactant of from 1:1 to 3:1, and the nonionic surfactant is in an amount of from 5% to 18.4% by weight of the composition, a weight ratio of the anionic surfactant to the co-surfactant of from 1:1 to 8:1 and free of fatty acid or salts thereof, results in overall improvement in storage stability, flash suds, suds mileage and grease cleaning benefits, thereby providing users with a <SHY> rounded liquid hand dishwashing cleaning product.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any composition disclosed or claimed herein or that it alone, or in any combination with any other reference or references, teaches, suggests or discloses any such composition. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A liquid hand dishwashing cleaning composition comprising:
from 15% to 40% of a surfactant system by weight of the liquid hand dishwashing cleaning composition, wherein:
the surfactant system comprises:
an anionic surfactant,
from 5% to 18.4% of a nonionic surfactant package by weight of the liquid hand dishwashing cleaning composition, and
a co-surfactant;
a weight ratio of the nonionic surfactant package to the anionic surfactant ranges from 1: 1 to 3:1;
the nonionic surfactant package comprises a mixture of a first nonionic surfactant and a second nonionic surfactant;
the first nonionic surfactant comprises an alkyl polyglucoside surfactant;
a weight ratio of the anionic surfactant to the co-surfactant ranges from 1: 1 to 8:1; and
the liquid hand dishwashing cleaning composition is free of fatty acid or salts thereof.

2. The liquid hand dishwashing cleaning composition of claim 1, comprising from 10.0% to 17.0% of the nonionic surfactant package by weight of the liquid hand dishwashing cleaning composition.

3. The liquid hand dishwashing cleaning composition of claim 1, wherein the weight ratio of the nonionic surfactant package to the anionic surfactant ranges from 1.1: 1 to 3:1.

4. The liquid hand dishwashing cleaning composition of claim 1, wherein the alkyl polyglucoside surfactant is selected from C8-C18 alkyl polyglucosides having a number average degree of polymerization of from 0.1 to 3.0.

5. The liquid hand dishwashing cleaning composition of claim 1, wherein the weight ratio of the first nonionic surfactant to the second nonionic surfactant ranges from 3:1 to 1:3.

6. The liquid hand dishwashing cleaning composition of claim 1, wherein the nonionic surfactant package consists essentially of the first nonionic surfactant and the second nonionic surfactant.

7. The liquid hand dishwashing cleaning composition of claim 1, wherein the second nonionic surfactant comprises an alkoxylated alcohol nonionic surfactant comprising:
an alkyl chain having on average from 9 to 15 carbon atoms, and
on average from 5 to 12 units of ethylene oxide per mole of alcohol.

8. The liquid hand dishwashing cleaning composition of claim 1, wherein the anionic surfactant comprises an alkyl sulfate anionic surfactant having an average degree of alkoxylation of less than 5.

9. The liquid hand dishwashing cleaning composition of claim 8, wherein the alkyl sulfate anionic surfactant has an alkyl chain comprising an average of from 10 to 14 carbon atoms.

10. The liquid hand dishwashing cleaning composition of claim 8, wherein the alkyl sulfate anionic surfactant comprises an alkyl ethoxy sulfate with an average degree of ethoxylation of less than 5.

11. The liquid hand dishwashing cleaning composition of claim 8, wherein the alkyl sulfate anionic surfactant comprises a branched alkyl sulfate anionic surfactant having an average level of branching of from 5% to 60%.

12. The liquid hand dishwashing cleaning composition of claim 1, wherein the weight ratio of the anionic surfactant to the co-surfactant ranges from 1: 1 to 5:1.

13. The liquid hand dishwashing cleaning composition of claim 1, wherein the weight ratio of the nonionic surfactant package to the co-surfactant ranges from 8:1 to 1:1.

14. The liquid hand dishwashing cleaning composition of claim 1, comprising from 12.0% to 16.0% of the nonionic surfactant package by weight of the liquid hand dishwashing cleaning composition.

15. The liquid hand dishwashing cleaning composition of claim 1, wherein the weight ratio of the nonionic surfactant package to the anionic surfactant ranges from 1.3:1 to 2:1.

16. The liquid hand dishwashing cleaning composition of claim 1, wherein the weight ratio of the first nonionic surfactant to the second nonionic surfactant ranges from 2:1 to 1:2.

17. The liquid hand dishwashing cleaning composition of claim 1, comprising from 10.0% to 17.0% of the nonionic surfactant package by weight of the liquid hand dishwashing cleaning composition, wherein:
the weight ratio of the nonionic surfactant package to the anionic surfactant ranges from 1.1:1 to 3:1;
the alkyl polyglucoside surfactant comprises a C8-C14 alkyl polyglucoside, having a number average degree of polymerization of from 1.0 to 2.0;
the weight ratio of the first nonionic surfactant to the second nonionic surfactant ranges from 2:1 to 1:2;
the second nonionic surfactant comprises an alkyl ethoxylated alcohol nonionic surfactant comprising:
an alkyl chain having on average from 9 to 15 carbon atoms, and
on average from 6 to 10 units of ethylene oxide per mole of alcohol;
the anionic surfactant comprises an alkyl sulfate anionic surfactant having an average degree of ethoxylation from 0.5 to 2.0;
the weight ratio of the anionic surfactant to the co-surfactant ranges from 1:1 to 5:1; and
the weight ratio of the nonionic surfactant package to the co-surfactant ranges from 5:1 to 2:1.

18. The liquid hand dishwashing cleaning composition of claim 1, comprising from 12.0% to 16.0% of the nonionic surfactant package by weight of the liquid hand dishwashing cleaning composition, wherein:
the weight ratio of the nonionic surfactant package to the anionic surfactant ranges from 1.3:1 to 2:1;
the alkyl polyglucoside surfactant comprises a C12-C14 alkyl polyglucoside having a number average degree of polymerization of from 1.2 to 1.6;
the weight ratio of the first nonionic surfactant to the second nonionic surfactant ranges from 1.5:1 to 1:1.5;
the second nonionic surfactant comprises an alkyl ethoxylated alcohol nonionic surfactant comprising:
an alkyl chain having on average from 10 to 14 carbon atoms, and
on average from 7 to 8 units of ethylene oxide per mole of alcohol;
the anionic surfactant comprises a branched alkyl sulfate anionic surfactant having 12 to 13 carbon atoms, an average level of branching of from 20% to 60%, and having an average degree of ethoxylation from 0.5 to 0.9;
the weight ratio of the anionic surfactant to the co-surfactant ranges from 1:1 to 3:1; and
the weight ratio of the nonionic surfactant package to the co-surfactant ranges from 4:1 to 2.5:1.

19. A liquid hand dishwashing cleaning composition comprising:
from 15% to 40% of a surfactant system by weight of the liquid hand dishwashing cleaning composition, wherein:
the surfactant system comprises:
an anionic surfactant selected from the group consisting of: alkyl sulphate anionic surfactant, alkyl sulphonate anionic surfactant, alkyl sulphosuccinate and dialkyl sulphosuccinate ester surfactants and mixtures thereof,
from 5% to 18.4% of a nonionic surfactant package by weight of the liquid hand dishwashing cleaning composition, wherein the nonionic surfactant package comprises a first nonionic surfactant and a second nonionic surfactant, wherein the first nonionic surfactant comprisess an alkyl polyglucoside nonionic surfactant, and
a co-surfactant;
a weight ratio of the nonionic surfactant package to the anionic surfactant ranges from 1:1 to 3:1;
the nonionic surfactant package comprises a mixture of a first nonionic surfactant and a second nonionic surfactant;
the first nonionic surfactant comprises an alkyl polyglucoside surfactant;
a weight ratio of the anionic surfactant to the co-surfactant ranges from 1:1 to 8:1; and
the liquid hand dishwashing cleaning composition is free of fatty acid or salts thereof.

20. A method of manufacturing the liquid hand dishwashing cleaning composition of according to claim 1, the method comprising:
mixing a first nonionic surfactant wherein the first nonionic surfactant comprises an alkyl polyglucoside surfactant, and a hydrotrope to form a premix; and
mixing the premix with an anionic surfactant, a co-surfactant and a second nonionic surfactant in an intermediate detergent stream to form the liquid hand dishwashing cleaning composition, wherein:
the hydrotrope is selected from the group consisting of sodium, potassium, and ammonium xylene sulfonate, ammonium toluene sulfonate, ammonium cumene sulfonate, and combinations thereof
.
